(19) United States
(12) Patent Application Publication
(10) Pub. No.: US 2005/0144529 A1
(43) Pub. Date: Jun. 30, 2005

(54) Method for defined derivation of software tests from use cases

(76) Inventors: Helmut Gotz, Nurnberg (DE); Klaus Pohl, Essen (DE); Andreas Reuys, Essen (DE); Josef Weingartner, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 10/956,657

(22) Filed: Oct. 1, 2004

Related U.S. Application Data
(60) Provisional application No. 60/507,718, filed on Oct. 1, 2003.

(51) Int. Cl. G06F 11/00

(52) U.S. Cl. 714/38

(57) ABSTRACT

A method is provided for deriving software tests from use cases. Thereby an activity digram is used to represent the possible use case scenarios. The test case scenarios are derived by applying coverage metrics on the activity diagram. The activities of the diagram are matched with an appertaining test. A test idea document is produced from the test case scenario. System test scenarios are created by concatenating the test case scenarios to a walk-through of the system. The system test cases are further enriched with activities to ensure the test precondition and to verify the test case scenario result. A test design document is produced for the system test.

### CROSS REFERENCE TO RELATED APPLICATIONS

The present application claims the benefit of U.S. Provisional Application No. 60/507,718, filed Oct. 1, 2003, herein incorporated by reference.

### BACKGROUND OF THE INVENTION

The invention relates to the field of software development in which “use cases” serve as a foundation for developing “test cases” that are utilized by software testers for testing a new product or system.

Many large systems are developed with shortcomings because the original system was designed inflexibly or the systems do not work as the users envisioned. In order to address such shortcomings in system development and to help manage the development of large systems, “use cases” were developed that provide a textual description of steps sequentially executed.

Use cases include descriptions of sequences of actions that a system performs. These actions provide an observable valuable result to a particular user. The use case takes into account variations on actions that may occur within a system. Use cases are part of the specification and describe the system behavior as small stories. Use cases provide a context for system requirements and help users and developers to communicate with one another in an easy to understand manner. The use case may be developed using nothing more sophisticated than a word processor, but advanced tools, such as IBM's Rational products, are also available.

The use case as a development tool is well known—it is a standard method for gathering requirements in many modern software development methodologies. For example, the use case is a part of the Unified Modeling Language (UML) (a language for specifying, visualizing, and constructing the artifacts of software systems) that has become the de factor industry standard software artifact notation.

Use cases are typically used at the early analysis stages of a project to describe what a system does, and not how the system does it. Use cases define the functions of a system, the system boundaries, and who/what uses the system (actors). Use cases specify typical system usage from a customer perspective and specify customer and market requirements. They illustrate routine system use to software engineers in order to give them a better understanding necessary to implement the new system. Additionally, they are used for validating the requirements to customers.

Some of the components that have historically been included in use cases include: 1) an activity diagram that displays action steps in a graphical format; 2) a main scenario description that provides a detailed description of a typical workflow; 3) alternative and exception scenarios, possibly provided by a short textual description; 4) supporting functionality that describe functions that can be performed at (almost) any time; 5) a list of requirements covered by each scenario step; and 6) additional attributes, such as pre-conditions, post-conditions, trigger conditions, etc.

Unlike use cases that tend to be user oriented in nature, test cases, while involving the user ultimately, tend to be more developer oriented. Developer-oriented test instances can be classified as a hierarchy involving: 1) unit tests that focus on test for single software units, and 2) integration tests that focus on the interaction of integrated software units. User-oriented test instances can be classified as a hierarchy involving: 1) product validation tests that focus on both a functional and non-functional validation of requirements; 2) system integration tests that focus on interoperability and interface conformance, and 3) system tests that focus on use cases and overall system functionality, such as Integrating the Healthcare Enterprise (IHE) workflows.

In previous design methodologies, test cases were derived only after the development of a system architecture that identified various components (software and hardware), the requirements for each of the components at various levels, and organization/interconnectivity of these components to produce the overall system. However, what has not been previously done is to utilize use cases for deriving system test cases with the use of activity diagrams that have been enriched with tester information.

### SUMMARY OF THE INVENTION

The present invention is directed to a method for deriving test cases for workflow based system requirements based on use case descriptions. This is advantageous because it helps to reduce the overall development cycle and permits an interactive approach by developing the system architecture in parallel with test cases used to address required functionality.

The invention is a test method for a test designer in three levels that provides at a stepwise definition of executable test scenarios via use case descriptions, activity diagrams, intended use case scenarios, test idea documents, extended test scenarios, and executable test scenarios. In the embodiment of the invention described below, three phases are provided that develop the tests and provide validation points for each phase.

At the end of each phase, explicit validation points exist for a review of the created products. In phase 1 (test idea phase), test idea documents are created based on intended test scenarios that are derived from activity diagrams incorporated in use cases. The test idea documents are validated with the product management to check that the intended requirements are tested correctly. In phase 2 (test design phase), a test design document is created based upon extended test scenarios that extend the former scenarios with additional steps to ensure the preconditions, check the post-conditions, and defined test criteria for the test steps. The test design document is validated with the test manager for an estimation of the test effort and support of the software quality. In phase 3 (test implementation phase), development-specific knowledge is used to refine the extended test scenarios to executable test scenarios. Therefore, concrete test data is inserted and a test level defined. The executable test scenarios are checked by the test implementers for completeness.

### DESCRIPTION OF THE DRAWINGS

Various embodiments of the invention are described more fully below with reference to the figures listed below and the appertaining following description.

FIG. 1 is a flow diagram illustrating the primary components of an embodiment of the invention;

FIG. 2 is a flow diagram illustrating the generation of a use case scenario from an activity diagram by traversing a path through the activity diagram;

FIG. 3 is a block flow diagram illustrating the association of the scenario activities with tests;

FIG. 4 is a block flow diagram illustrating the association of test activities for the scenario tests; and

FIG. 5 is a hierarchical block diagram illustrating the hierarchy of use cases.

### DETAILED DESCRIPTION OF THE PREFERRED EMBODIMENTS

The present invention is described below using an illustrative embodiment that relates to Siemens' SIRIUS medical solution system—however, the invention is not to be limited to this exemplary embodiment but rather should be construed to encompass all embodiments that would occur to one of skill in the art.

This methodology utilizes the use cases and their appertaining activities in order to derive systematic and reproducible test cases comprising test sets from the given use cases/scenarios. This approach may be complemented by standard computer aided software engineering (CASE) tools.

The test cases are then used in further product tests or system tests for validation. The method permits derivation of an exact and definite quantity of test cases from the use cases. Furthermore, it is also possible to make a conclusion about the completeness of the software test to be implemented, as well as to reveal the appropriateness of a particular individual test. In audits (for example, implemented by the TÜV or FDA) the methodology is effective to precisely demonstrate this.

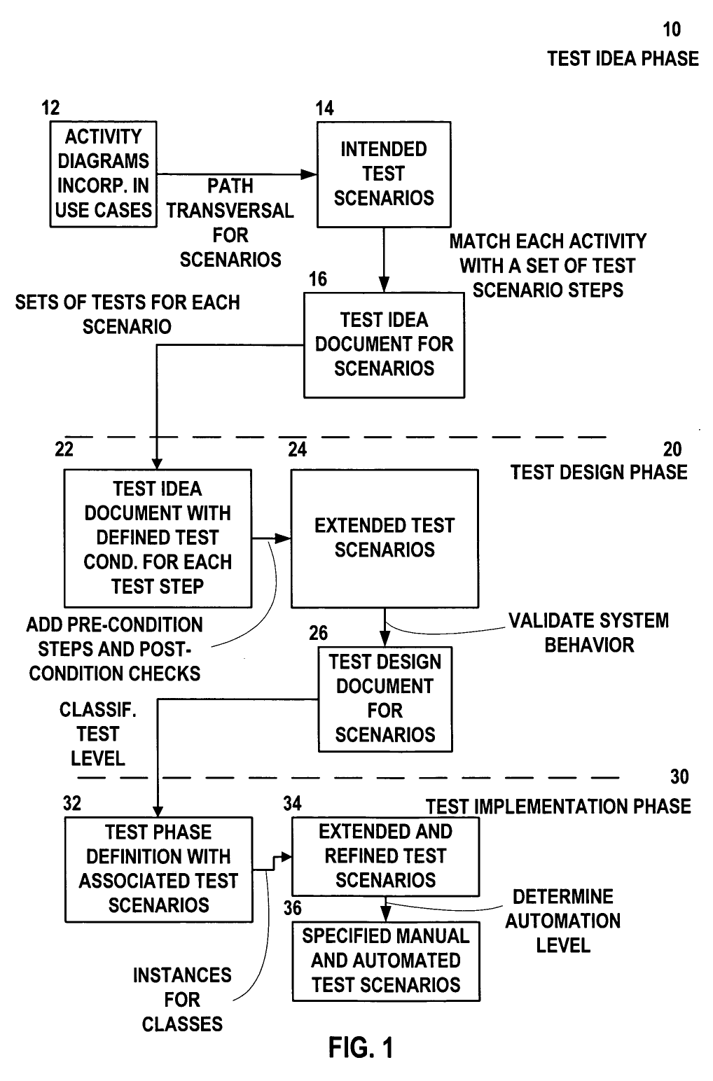

According to an embodiment of the invention, FIG. 1 illustrates the primary phases for generating test cases comprising sets of tests from use cases defining multiple activities. As illustrated in FIG. 1, the method includes a test idea phase 10, a test design phase 20 and, according to one embodiment of the invention, a test implementation phase 30.

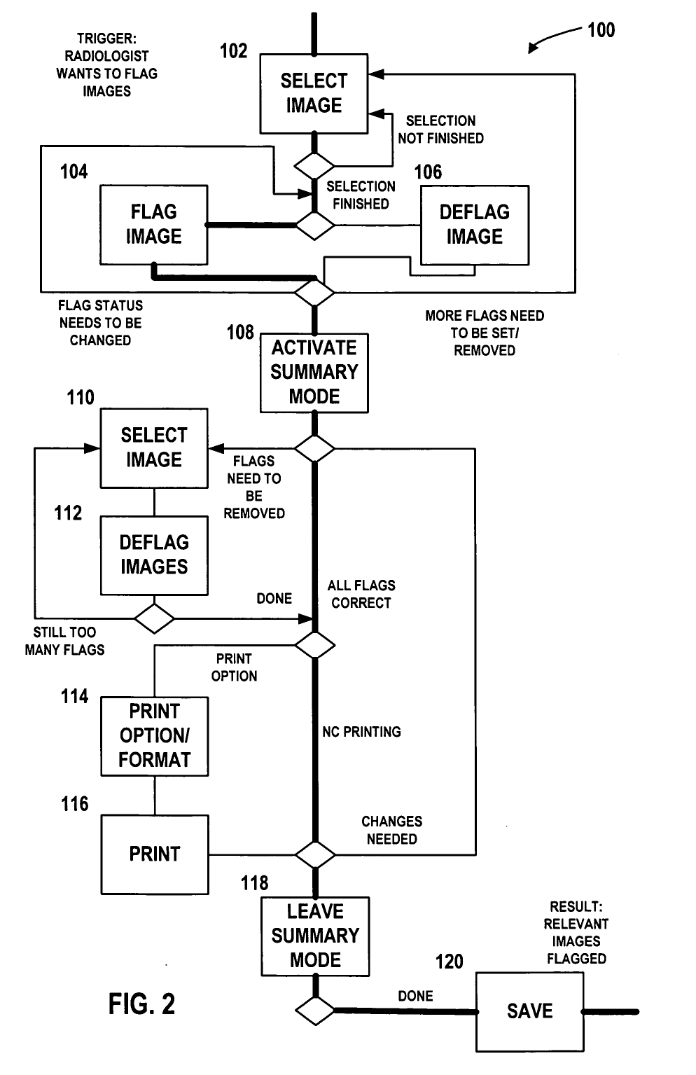

The use cases are comprised of activity diagrams 100 (FIG. 2) incorporated in use cases that comprise multiple activity steps/elements 12, the activity diagrams 100 being are structured as a flowchart or flow diagram. Intended test scenarios 14 are derived, as explained in more detail below, by traversing various paths through these activity diagrams 100. A test case scenario is created corresponding to a use case scenario by matching each use case activity with an appertaining test. A test idea document 16 may then be generated from the so developed test case scenarios. It should be noted that a test idea document 16 may either be in a tangible form such as one printed on a paper media, or in electronic form such as one stored on a computer based media or in memory. The test idea document is validated with product management to check that the intended requirements are tested correctly.

In a test design phase 20, the tests within the test idea document 16 are extended and enriched with defined test conditions and specific activities for each test step 22. Pre-state and post-state tests and checks are associated with each of the test scenarios to produce extended test scenarios 24. The extended test case scenarios may then be assembled into a test design document for scenarios 26. As with the test idea document, the test design document may be a physical document or one stored in electronic form. Each of the documents described herein need not reside in one single location but may be spread across systems (electronic) or locations (paper, tangible digital media). Validation is performed by a test manager in order to estimate the test effort and support the software quality.

In the test implementation phase 30, a test phase or level definition, such as a unit test, an integration test, or a system test is associated with tests in the design scenario or with the scenario as a whole 32. The test scenarios are extended and refined by, e.g., replacing classes that describe various criteria and parameters with actual instances of the class data 34. Finally a determination is made of which tests may be automated and which tests should be manual 36. For automated tests, various scripts and programs are developed that are used to implement automated testing.

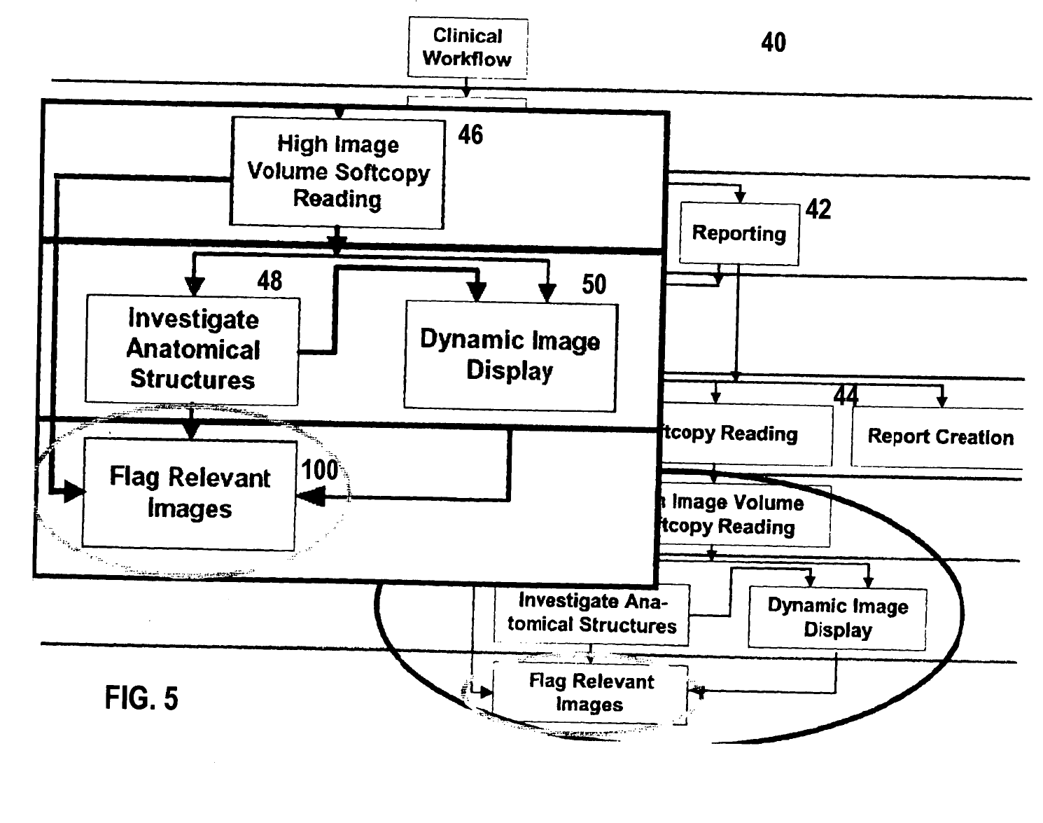

The embodiment described below relates to an example utilizing test cases in the field of radiology. The use cases may be arranged in an overall hierarchy 40, as illustrated in FIG. 5. In the illustrative exemplary embodiment, the broad system relates to a reporting 42 aspect of a clinical workflow. An aspect of reporting 42 is high image volume softcopy reading 46, which involves, at a lower level, investigating anatomical structures 48 and a dynamic image display 50. The primary focus, for illustrative purposes, is the use of the flag relevant images 100 use case. In this case, a radiologist wants to flag relevant medical images from an examination or medical procedure for later use.

Use Cases

As noted previously, use cases can make use of: 1) an activity diagram, 2) a main scenario description, 3) alternative scenarios, 4) exceptional scenarios, 5) supporting functionality, and 6) a list of requirements, among other things.

A main scenario description for the flag relevant images might flow as follows. The following procedure is repeated until all relevant images are flaged. 1. The radiologist identifies several single relevant (not flagged) image(s) by positioning the mouse on the image(s). He clicks a predefined function key to apply a specific flag on the image(s); 2. The system responds by indicating that the image is (de-) flagged; 3. The radiologist activates the summary display mode by clicking a predefined function key; 4. The system shows only all flagged images of the series in one summary display mode; 5. The radiologist may identify an image(s) which he decides is not that relevant and deselects it by positioning the mouse on it—he presses the predefined function key to deflag the image; 6. The system shows only the flagged images, the deflagged images being removed from the summary display mode; 7. The radiologist leaves the summary display mode by clicking again the predefined function key; 8. The system exits the summary display mode and shows again the complete exam in the previous display mode; 9. The radiologist ends soft copy reading, closes the exam, and stores the flags (together with all performed changes of the exam); and 10. The system closes the exam and saves the flags.

An alternate scenario might include permitting the radiologist to flag multiple images at once. The use case descriptive activity might state, “The radiologist identifies several relevant (not flagged) images via the mouse. He uses the soft key to apply a specific flag on the selected images.”

Supporting functionality could include one in which the radiologist wishes to print the flagged image(s), which might include a description, “The radiologist will select all flagged images from the summary display and transfer them to the print option.” Exceptional scenarios might involve situations like error recovery from various failures that might occur.

An analysis of the uses cases includes looking to the main goals and side effects. The use case analysis of the main goals looks to considering an overall activity diagram covering, to the extent possible, alternative scenarios, exceptional scenarios, and supporting functionality. The scenarios describe in detail the precondition state, a semi-formal description of user/system interactions, and the post condition state. These serve to drive the workflow based system test procedures/scenarios.

Looking at the side effects for the use case analysis, the issues can be classified as: 1) major issues, such as conflicts, ambiguities, missing scenarios or steps of the scenarios, identifying unspecified scenarios, and clarifying “to-be-determined” (TBD) issues; and 2) minor issues, such as missing updates, numerations, and typographical errors. These issues are then used to directly provide feedback to the product management and development teams.

An example of a major issue side effect is described as follows. In the main scenario of “flag relevant images”, step 9 indicates that when the radiologist ends flagging of the images, he closes the exam and stores the flags together with all performed changes of the exam. This does not fit within the procedure “flagging images” arranged within the use case “investigate anatomical structures” because it contains an element related to all performed changes of the exam.

The use case side effects can help identify various aspects of the system, including some contradictions within the use case hierarchy, particularly with respect to preconditions. System reactions may not be clear, e.g., some of the selections may remain active after setting a flag on the relevant images, and the user's answer to some of these system reactions may be missing.

Using the use case to drive the test process results in feedback to the project manager earlier in the process than conventional development methodologies. This feedback can include clarifying requirements and/or adding new requirements, clarifying, ambiguities, and removing errors before any code is written. Utilizing use cases to directly drive the test process helps to prevent errors in the first place. Testing is stared as early as possible, which permits test planning to be improved. It provides the first answer to the question “are we building the right product?”

Derivation of Test Case Scenarios from Use Case Scenarios

An embodiment of the invention breaks test development into three phases that include a test idea phase, a test design phase, and a test case implementation phase. Each of these phases can result in a descriptive document or deliverable being produced.

Test Idea Phase

The overall concept of the Test Idea Document borrows the use of the Activity Diagram, Use Case Scenarios, New Scenarios, and Covered Requirements directly from the use case analysis. The overall use case activity diagram for “flag relevant images” is provided in FIG. 2.

FIG. 2 illustrates an example of the derivation of a test case from the source in the use case. In order to create Scenario 1, which is to flag a single image, a first path is highlighted (bold) in the activity diagram 100 for the use case steps/elements 102-120. A source description in this use case could be, e.g., (as described above) “The radiologist identifies several single relevant (not flagged) image(s) by positioning the mouse on the image(s), and clicks a predefined function key to apply a specific flag on the single image(s).”

The various steps 102-120 in the activity diagram 100 may utilize step identifiers (not shown) that can be used to identify a source for a particular step that may be associated with a particular requirement key. The requirement key is an index to a particular associated requirement or set of requirements.

Tracing through the first path indicates that for Scenario 1, which is to flag a single image, a source may be provided with an identifier and the first path through steps/elements select image 102, flag image 104, activate summary mode 108, leave summary mode 118 and save 120 path is identified, along with the identifiers reflecting the requirement keys. This serves to identify the requirements covered by the scenario, but in terms of what is shown in the use case. A derived scenario may include a scenario identifier, e.g., Scenario 1: flag single image, a path 102-120, a source for the identified path, requirement keys, name and number, a path in the overall activity diagram, a main focus, and requirements covered by the particular scenario.

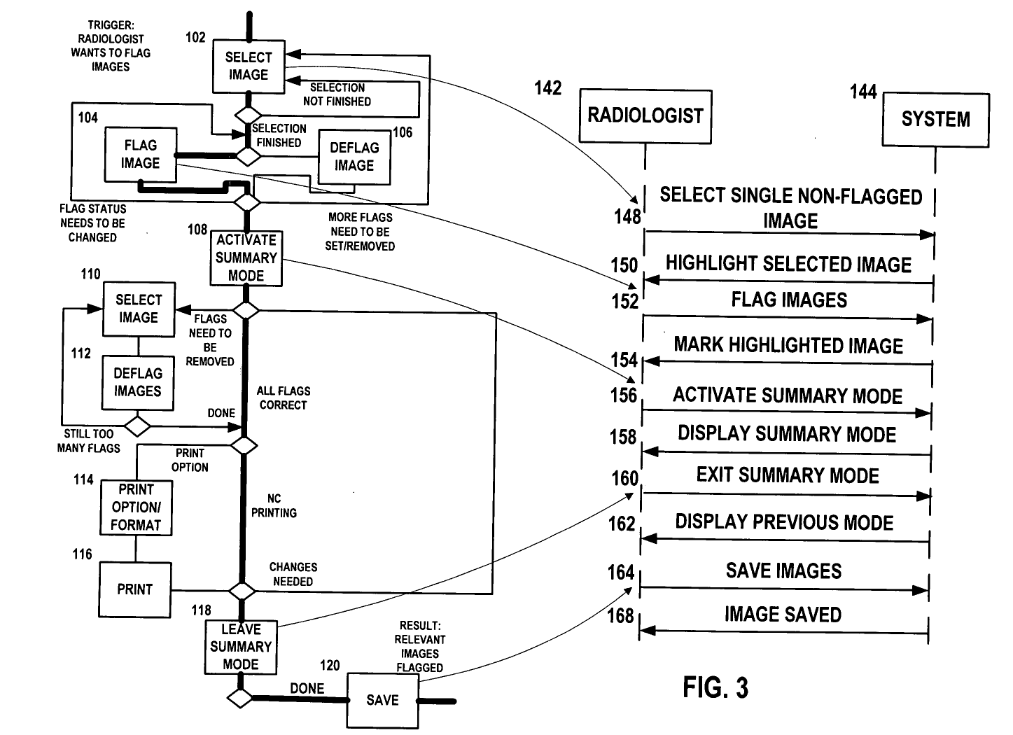

The next step, illustrated in FIG. 3, shows how the derived test scenario sets are created from the activity diagram 100 of the use case. A precondition 146 may be present that includes, e.g., that the complete exam is loaded and function keys are predefined.

For each element 102-120 in the path, a corresponding series of test sets is developed. For example, from the “select image” box 102 in the activity diagram 100, the first test set is initiated by the radiologist 142 “select single, not flagged image” 148; this is paired with the system 144 response of highlighting the selected image 150. From FIG. 3, it can be seen that each and every box 102, 104, 108, 118, 120 on the activity diagram 100 in the first path corresponds to a test set (user action, system response) 148, 150; 152, 154; 156, 158; 160, 162; 164, 168 that is provided. There is no requirement that this type of pairing is utilized, but only that each box on the activity diagram be correlated with one or more tests.

For the select image element 102 of the activity diagram, a test is provided for demonstrating select single not flagged image 148 from the radiologist 142 to the system 144. A paired test is provided for demonstrating highlighting the selected image 150. For the next element in the path/scenario flag images 104, a test is provided for demonstrating the flagging of images 152 and a corresponding test for showing marking of the highlighted images 154 is provided. Similarly, the activate summary mode element 108 has the corresponding tests activate summary mode 156 and display summary mode 158 for the radiologist 142 and system 144 respectively. The next path element leave summary mode 118 is associated with the exit summary mode test 160 and responsive display previous mode 162. Finally, the save element 120 corresponds to the save images 164 and images saved 168 tests.

Additional scenarios can be created in addition to the path traversal in the overall activity diagram 100 described above, which only generates tests for a limited number of valid sequences of events, which serves to reduce the number and scope of the tests that must be performed. These additional scenarios can be utilized to test other aspects of the system.

Additional scenarios can be identified by: 1) testing cross functionalities that may be utilized (e.g., save, undo, print, window zoom), 2) deliberately using inappropriate functions (e.g., deflagging an image that is not flagged); and 3) deliberately using supporting functionality inappropriately (e.g., printing without a summary display mode).

Using this method of path transversal to derive test scenarios advantageously develops test sets in which each element of the activity diagram is associated with at least one test. An overall test idea document may be produced from the test sets created by the various derived scenarios. As noted previously, this document may be in physical tangible form or in electronic form.

Test Design Phase

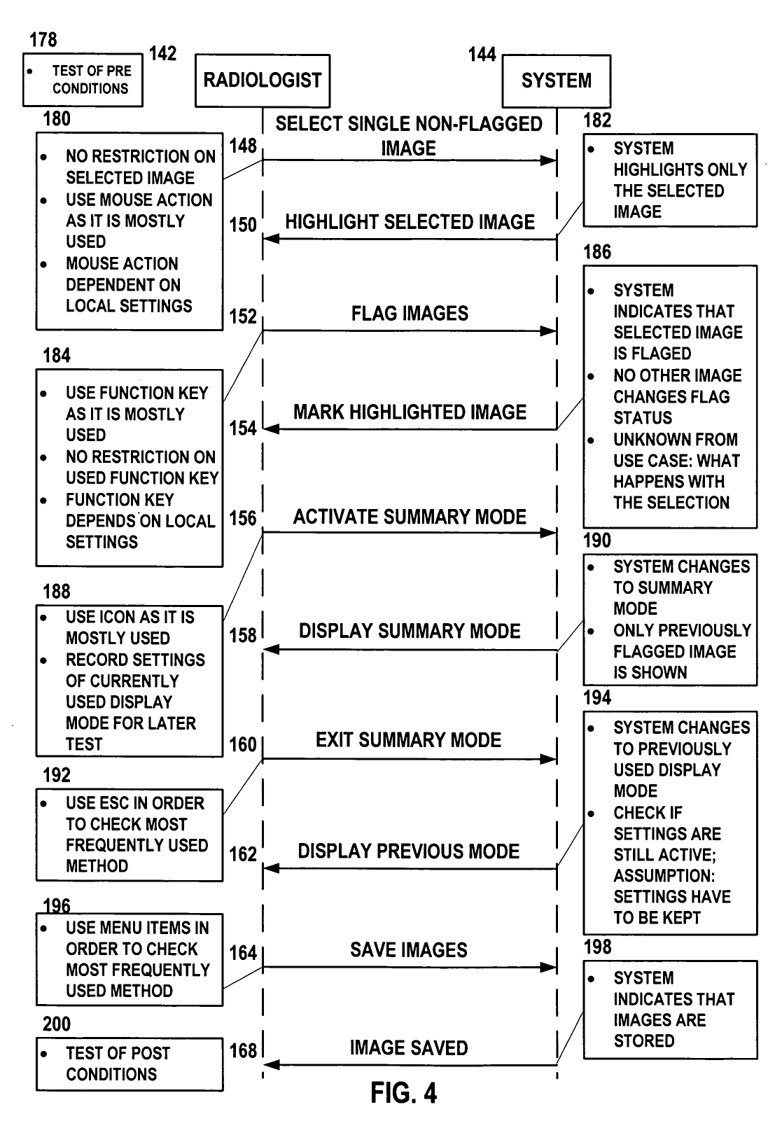

FIG. 4 provides an example of migrating, in the test design phase 20 (FIG. 1), the developed test sets from the test idea document 16 into the test design document 26. Generally speaking, the test design document 26 can be produced from the test idea document 16, with the overall result that test case designs/scenarios are created directly from the use case scenarios. This involves introducing test designs for checks for the precondition state 178 and testing for the post condition state 200. In defining the test design document 26, calls should be made unique and explicit, where necessary. Data should be quantified, and one should define classes, not instances, for test data in order to generalize as much as possible. Ideally, as many possible situations should be used at one time, and decisions explicit to the implementer should be delayed if not necessary in the design.

FIG. 4 illustrates an application of this concept to the flag single image use case. Here, the checks for preconditions 178 are performed by, e.g., loading the appropriate exam if it is not loaded, and defining the function keys if they are not defined. At this stage, test data classes have been defined, and the test criteria are illustrated for the test pairs. Finally, the test of post conditions 200 is performed.

In more detail, for the select single non-flagged image test 148 for the radiologist, a test design includes that no restriction is made on the selected image, mouse action is used as it is normally used and that the mouse action is dependent on local settings 180. For the system response of highlighting the selected image 150, the test design should be that the system highlights only the selected image 182.

For the flag images test 152, the design includes using the function key as it is normally used, no restriction on the used function key, and the function key depends on local settings 184. The system should respond by the mark highlighted image test 154 with the test description being that the system indicates that the selected image is flagged, no other image changes the flag status—what is unknown from the use case is what happens with the “selection” attribute 186.

For the activate summary mode test 156, the test design includes using an icon as it is normally used and recording settings of currently used display mode for a later test 188. The system response test of display summary mode 158 has the associated test design that the system changes to summary mode and that only the previously flagged image is shown 190.

For the exit summary mode test 160, the test design includes using the ESC key in order to check the most frequently used method 192. The system response test of displaying the previous mode 162 is coupled with the test design that the system changes to the previously used display mode and a check is made to see if the settings are still active, with a presumption that the settings have been kept 194.

Finally, for the save images test 164, a test design is provided that menu items are used in order to check the most frequently used method 196. The system response test that the image is saved 168 has the description that the system indicates the images are stored 198.

By traversing various possible paths through the use case activity diagram 100, a large number of scenarios may be developed. The number of potential paths could be large, if the loops are traversed multiple times. A scenario may be created for each potential path in the activity diagram 100. Moving up to a higher level in the hierarchy (FIG. 5), a much larger number of scenarios with their respective test designs might be possible for, e.g. the overall high image volume softcopy reading 46. It is important to be able to minimize the number of test scenarios so that all possible combinations do not have to be utilized.

One way of minimizing the number of test scenarios is to provide a prioritization associated with a particular test or test scenario. Test planning specifies which tests must be executed at what time—all test do not have to be executed the first time during the system test phase. Instead, those tests that are the most important to critical system operation may focused on early, while test relating to less important functionality can be deferred and/or run less frequently. Thus, the test may be provided with a priority, designating, e.g., critical tests most important for system operation, intermediary tests that are important but not critical, and low level tests that test peripheral aspects of component or system operation.

Once the overall activity diagram is created, one must decide which tests will be derived. Since there are a huge number of possibilities for various loops through the use case activity diagram, there are two approaches that may be used to help reduce the number: 1) path coverage, in which each possible path through the diagram is covered; and 2) branch coverage, in which each branch after a decision is taken at least once are identified. By applying the branch coverage and test analysis, it is possible to reduce, e.g., 256 possible paths from path coverage to 24 test designs.

Furthermore, when applying the test designs according to the exemplary hierarchy of use cases devised (see FIG. 5), in one study there were over 46,656 combinatorial possibilities based on a premise that each and every path must be covered—this is an unworkable situation. Using the procedures described above, this can be reduced down to 24 test sets in 66 test cases by defining a maximum number of test designs/cases, making it possible to cover nested use cases (those use cases within others). The advantage to this approach is that one knows exactly which paths are selected, and each test case has its source defined. The drawback is that one cannot say that the system will behave perfectly by running this limited number of test cases, i.e., there may be unanticipated interaction effects. A further advantage is that this provides a walkthrough of the whole system, although this process can be lengthy.

One can reduce the amount of test cases by creating complete system workflows. In this case, the test cases from the different use cases are concatenated to model a complete system walkthrough. For example, in FIG. 5, test cases may be concatenated from “investigate anatomical structures” 48, “dynamic image display” 50, and “flag relevant images” 100. While such an approach decreases the total number of test cases to be executed, it also increases the size of the test cases.

Thus, the test design represents multiple functions according to the use case. It can be seen that the preconditions, including the availability of the patient exam by worklist, the cine mode, 2D, 3D and multiple screens are supported, as well as a request from a referring physician. The post condition is that a softcopy reading of a patient exam is finished.

One of the problems in determining the test designs is that there may be unclear or inexplicit requirements of a review document for the test design, with concerns revolving around whether the use case-based system understanding is correct and whether the test focus is correct. This problem can be addressed by focusing on the use case activity diagrams as they relate to the structure of the use cases, and relating the test designs from an overview of the functionalities illustrated by the use cases.

Developing the test designs from use cases helps ensure that both the use case-based system understanding is correct and that the focus of the tests, e.g., the test level, scope, objectives is correct. This can be performed for test designs addressing global requirements for the system test, the global system design for the system integration test, and the product requirements for the product validation test. The test may be validated by a trial in an exemplary review.

In an embodiment, for the test design overview, a test idea is created that represents a domain-specific class of scenarios according to functionality. A test design is given a name by which it can be referenced and the priority of the tester may be included. The course of the use case activity diagram should be reflected in the test design documentation. Thus, the test designs developed from scenarios from the use cases could identify, among other things, the test purpose, activity diagram path, source, test priority, requirement keys, and any preconditions/postconditions. Particular formats or style guides could be utilized to ensure uniformity within the test definition database.

The functional tests and respectively the test design scenarios should reference the requirements to show the complete coverage. Therefore, the tests must precisely reference the requirements (system, intermediate or unit level), that references are made to all requirements, and that requirements that are not included are managed in some particular manner.

Requirements that are not included may be managed by applying the use case methodology to embody old requirements. Additionally, many requirements may be tested traditionally without utilizing use cases. Finally, requirements could be tested without utilizing the derivation methodology, or could utilize a generation of further use cases.

Utilization of Tools for Test Design Review Documents

It is possible, in an embodiment of the invention, to use commercially available tools to assist in the development of test design review documents 26 (FIG. 1). Once such tool is TestDirector by Mercury Interactive (see, e.g., http://www.mercuryinteractive.com/products/testdirector/; Sep. 17, 2004). This product provides a global test management solution to help business deploy applications quickly and effectively. Use of such a product permits a consistent design of the review document, naming conventions for the test, and other necessary documentation and information related to the tests. The TestDirector product can be utilized to easily generate such a document by using the “description” and “attachment” data. An example of common data fields could include: 1) Description (“Head”, which includes a name, purpose, requirement keys, etc.), 2) Attachment, which could include a test design as an image, and 3) a solved problem, which may include graphics that can be directly printed on the report.

Alternately, review documents could be created utilizing and IBM product called Rational Rose. Rational Rose is a comprehensive software development tool that supports the creation of diagrams specified in the Unified Modeling Language (UML). See http://www-306.ibm.com/software/rational/. It is possible to utilize a copy and paste to transfer test designs from Rational Rose, and one can utilize the TestDirector for support of the test implementation.

Test Case Implementation Phase

Finally, in an embodiment of the invention, in a test implementation phase 30, the test implementation scenarios 36 may be derived from the test design scenarios 26. When possible, automated tests may be designed to provide maximum flexibility to the overall testing schedule. The various tests and test scenarios may be classified as being either automated or manual 36, and automated programs or scripts for running the tests are developed and associated with the tests designated as automated. Nonetheless, for a system with even a modest amount of complexity, manual tests may still be required—for these, the test design serves as a template for the manual test.

During the implementation phase, aspects that are unimportant with respect to the design of the test, but nonetheless must be included to actually implement the test, i.e., “design don't cares” (e.g., changing “flag image” to “flag image by using right mouse”) are specified to extend and refine the test scenarios. The classes should all filled with instances of the classes 34 (e.g., changing “load patient picture with wrong pixels” to “load Roberta Johnson, select the second picture by using LMB”); all actions are specified in detail, such as providing coordinates for an object to be drawn, if possible, to create unique and repeatable test cases.

Various aspects of the test phases may be implemented by utilizing commercially developed tools to assist in applicable components. Finally, it is also desirable to implement traceability in the testing and its relationship to the user cases. Use cases tend to relate to a system specification, and therefore derived test cases/scenarios are generally for the system test, but the derived test designs can be used to support other test levels.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

1. A method for deriving a software test case from activity diagrams incorporated in a use case, comprising:
providing an activity diagram comprising a plurality of activities that are part of a use case;
in a test idea phase:
traversing a path through the activity diagram, thereby creating a use case scenario comprised of a plurality of activities associated with the path;
matching each activity of the plurality of activities within the use case scenario with an appertaining test;
creating a test case scenario from the matched tests;
producing a test idea document from the test case scenario; and
validating the test idea document by project management to ensure intended requirements are tested correctly;
and
in a test design phase:
defining and associating test activities for each test within the test idea document;
creating an extended test activity scenario by arranging the test activities according to the test case scenario;
adding a pre-state scenario check activity at a beginning of the extended test activity scenario;
adding a post-state scenario check activity at an end of the extended test activity scenario;
producing a test design document from the extended test activity scenario; and
validating the test design document by a test manager to estimate test effort and support software quality;
and
in a test implementation phase:
inserting concrete test data into the test activities of the test design document;
defining a test level to the test activities of the extended test activity scenario of the test design document or to the extended test activity scenario itself;
producing an executable test scenario based on the extended activity scenario incorporating the concrete test data and the test level information;
producing an executable test scenario document from the executable test scenario; and
validating the executable test scenario document by a test implementer for completeness.

2. The method according to claim 1, further comprising:
traversing more than one path through the activity diagram, thereby creating multiple use case scenarios;
producing multiple test case scenarios from sets of matched tests;
producing the test idea document that includes each of the test case scenarios;
producing multiple test activity scenarios from the multiple test case scenarios of the test idea document; and
producing the test design document from the multiple test activity scenarios.

3. The method according to claim 2, further comprising:
minimizing the number of produced scenarios by utilizing an adapted branch covering instead of path coverage.

4. The method according to claim 2, further comprising:
minimizing the number of produced scenarios by defining combinations of the scenarios that realize a walk-through of the whole system.

5. The method according to claim 2, further comprising:
minimizing the number of produced scenarios by assigning a high or low priority to each test or test scenario and including only those tests or scenarios having a high priority.

6. The method according to claim 2, further comprising:
minimizing the number of produced scenarios by including more than one functionality in a test design scenario.

7. The method according to claim 1, wherein inserting concrete test data in the test implementation phase comprises replacing classes of parameters within the tests with actual instances of parameters.

8. The method according to claim 7, further comprising, in the test implementation phase:
assigning all tests as being either an automated test or a manual test; and
for all automated tests, providing a program or script configured to implement the test automatically.

9. The method according to claim 1, further comprising:
associating each test with a test level selected from the group consisting of: a unit test, an integration test, and a system test.

10. The method according to claim 1, further comprising:
storing the test idea document in electronic form in a computer-based system.

11. The method according to claim 1, further comprising:
storing the test design document in electronic form in a computer-based system.

12. The method according to claim 1, further comprising:
associating specific system requirements with each test.

13. The method according to claim 1, further comprising:
further utilizing a main scenario description, at least one alternative scenario description, at least one exceptional scenario description, supporting functionality, and a requirements list in the development of the test case scenario.

14. The method according to claim 1, further comprising:
determining side effects for the use case analysis that are classified as major issues and minor issues.

15. The method according to claim 1, further comprising:
generating feedback from the matching of tests and test case scenarios prior to developing code selected from the group consisting of clarifying requirements, adding additional requirements, clarifying ambiguities and removing errors.

16. The method according to claim 1, further comprising:
managing a traceability of test cases to use cases in a database.
